(19) United States
(12) Patent Application Publication
(10) Pub. No.: US 2003/0000257 A1
(43) Pub. Date: Jan. 2, 2003

(54) Single step fiber preparation

(76) Inventors: Chester Hann Huei Chang, Painted Post, NY (US); Scott Winfield Deming, Elmira, NY (US); Lewis Kirk Klingensmith, Corning, NY (US); Woody Brian Swan, Painted Post, NY (US); Patrick Aaron Parks, Elmira, NY (US); Thomas Shawn Moag, Horseheads, NY (US); Michael Albert Joseph II, Corning, NY (US)

Correspondence Address: JONES VOLENTINE, P.L.L.C., SUITE 150, 12200 SUNRISE VALLEY DRIVE, RESTON, VA, 20191, US

(21) Appl. No.: 09/896,928

(22) Filed: Jun. 29, 2001

(51) Int. Cl. C03B 37/16

(52) U.S. Cl. 65/425; 65/433; 65/473; 65/503

(57) ABSTRACT

A method of optical fiber preparation includes concurrently processing a plurality of optical fibers which have a substantially vertical orientation, and the concurrent processing is substantially automated.

A fiber preparation apparatus includes an optical fiber holder transport which holds at least one vertically oriented optical fiber. The fiber preparation apparatus further includes at least one fiber processing station.

### FIELD OF THE INVENTION

The present invention relates generally to optical fiber communications, and particularly to a method and apparatus for preparing an optical fiber for fusion to another optical fiber, optical waveguide or optical device; for preparing an optical fiber for polishing or for forming a lens; and for preparing an optical fiber for optical or geometrical measurements.

### BACKGROUND OF THE INVENTION

Optical fibers generally comprise an inner glass layer circumferentially surrounded by an outer glass layer. The inner glass layer has an index of refraction that is greater than the index of refraction of the outer glass layer to provide waveguide capability. The inner layer of the optical fiber waveguide is conventionally referred to as the core, and the outer layer of the optical fiber waveguide is conventionally referred to as the cladding. The optical fibers generally have a very small diameter, and are susceptible to external influences such as mechanical stress and environmental conditions. These environmental conditions can adversely impact the optical fiber. To protect the fiber from these environmental conditions, one or more layers of protective material circumferentially surround the optical fiber. By convention, these protective outer layers are referred to as the buffer layer, coatings.

Certain uses of optical fibers require that a portion of the buffer layer be removed from an end of the fiber or a portion of the fiber that is remote from the ends of the fiber. For example, to make an optical fiber coupler, the buffer is stripped from the end portion of at least one optical fiber and a portion remote from the end of another fiber, and the stripped portions of the optical fiber are fused together in a side-by-side relationship. Alternatively, the optical fiber may be fused together in a butt-coupled relationship. In this relationship, the endfaces of the fiber are coupled together and fused.

The buffer layer may be manually stripped from an optical fiber by placing the fiber within an hand-held tool, bringing blades of the tool into contact with opposite sides of the coating layer, and then moving the tool relative to the axis (the optic axis) of the coated optical fiber. The bare portion of the optical fiber must then be cleaned. This may be achieved by a variety of techniques, such as wiping the fiber manually with a cloth wetted with alcohol or suitable solvent to remove particles of the buffer layer that have deposited on the bare portion of the optical fiber in the buffer stripping process. The cleaning process also removes any other contaminants from the surface of the optical fiber. The cleaning process may also be effected using types of equipment that eliminate the need for manually cleaning. These equipment are useful because manually physical contact is avoided. In addition to safety issues, the cleaning process is generally faster, cleaner, and avoids any defects in the fiber due to manual handling.

The next step in the process for preparing an optical fiber for fusion is a cleaving process. The cleaving process is designed to provide a substantially planar surface at a particular angle relative to the optic axis. For example, the plane of the endface of the optical fiber may be perpendicular to the optical axis of the optical fiber. This has been done traditionally in a manual step using commercially available cleaving tools. The manual sequence includes clamping the optical fiber and cleaving the fiber with the cleaving tool. This process has certain drawbacks that ultimately impact the optical characteristics of the fiber. For example, if the clamp is improperly loaded, the cleave blade may be misaligned relative to the fiber. Moreover, some optical fibers are shipped in a pigtailed fashion. Moreover, some fibers include an additional large diameter protective coating. A curl or curve in the fiber may result that may adversely affect the alignment of the fiber during cleaving. This may result in a poor cleave angle tolerance, and ultimately adversely impact the optical characteristics of the fiber in its final application. To this end, often the cleaving is effected by applying tension to the optical fiber. If the tension is too great, the optical fiber can experience stress related damage. If the tension is not great enough, the cleave blade cannot effect a good cut and an undesireable cleave angle may result.

Finally, the above described conventional methods of stripping, cleaning and cleaving of an optical fiber involve a variety of transport steps from one station to the next. With each of these steps, the operator is exposed to injury and the optical fiber is exposed to potential damage. Furthermore, cycle times may be adversely impacted by manual transportation. There is also a relatively high degree of operator involvement and effectiveness required to produce acceptable cleaved ends.

What is needed, therefore is a method and apparatus for preparing an optical fiber which overcomes the drawbacks of conventional techniques and apparati described above.

### SUMMARY OF THE INVENTION

According to an exemplary embodiment of the present invention, a method of optical fiber preparation includes concurrently processing a plurality of optical fibers which have a substantially vertical orientation, and the concurrent processing is substantially automated.

According to another exemplary embodiment of the present invention, a fiber preparation apparatus includes an optical fiber holder transport which holds at least one vertically oriented optical fiber. The fiber preparation apparatus further includes at least one fiber processing station.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a flow chart of a fiber preparation sequence in accordance with an exemplary embodiment of the present invention.

FIG. 2 is a perspective view of a machine for preparation of an optical fiber in accordance with an exemplary embodiment of the present invention.

FIG. 3 is a top view of a fiber preparation machine in accordance with an exemplary embodiment of the present invention.

FIG. 4 is a perspective view of a fiber holder transport accordance with an exemplary embodiment of the present invention.

FIG. 5(a) is a perspective view of a fiber straightening station in accordance with an exemplary embodiment of the present invention.

FIG. 5(b) is a cross-sectional view of a fiber straightening station taken along the line 5(b)-5(b) in FIG. 5(a).

FIG. 6(a) is a perspective view of a fiber stripping station in accordance with an exemplary embodiment of the present invention.

FIG. 6(b) is another perspective view of a fiber stripping station in accordance with another exemplary embodiment of the present invention.

FIG. 7 is a perspective view of a cleaner assembly in accordance with an exemplary embodiment of the present invention.

FIG. 8(a) is a perspective view of a cleaver assembly in accordance with an exemplary embodiment of the present invention.

FIG. 8(b) is a perspective view of a cleaver assembly in accordance with another exemplary embodiment of the present invention.

FIG. 9 is a functional block diagram of a machine for preparation of optical fibers in accordance with an exemplary embodiment of the present invention.

FIG. 10 is a functional block diagram of a machine for preparation of optical fibers in accordance with an exemplary embodiment of the present invention.

FIG. 11 is a functional block diagram of a machine for preparation of optical fibers in accordance with an exemplary embodiment of the present invention.

FIG. 12 is a functional block diagram of a machine for preparation of optical fibers in accordance with an exemplary embodiment of the present invention.

FIG. 13 is a functional block diagram of a machine for preparation of optical fibers in accordance with an exemplary embodiment of the present invention.

FIG. 14 is a functional block diagram of a machine for preparation of optical fibers in accordance with an exemplary embodiment of the present invention.

FIG. 15 is a functional block diagram of a machine for preparation of optical fibers in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art that the present invention may be practiced in other embodiments that depart from the specific details disclosed herein. In other instances, detailed descriptions of well-known devices and methods may be omitted so as not to obscure the description of the present invention.

Briefly, the present invention relates to a method and apparatus for concurrently processing a plurality of optical fibers having a substantially vertical orientation, where the concurrent processing is substantially automated. For example, an illustrative method and apparatus are disclosed for preparing an optical fiber for cleaving and the cleaving thereof. According to an exemplary method of the present invention, the optical fiber is disposed in a machine. The machine moves the optical fiber to a straightener station where the optical fiber is straightened. The machine moves the optical fiber to a stripper station where the buffer layer is stripped from at least a portion of the optical fiber. The machine moves the optical fiber to a cleaning station where the optical fiber is cleaned. The machine moves the optical fiber to a cleave station where the optical fiber is cleaved.

The present invention is advantageous because a variety of steps may be carried out which conventionally have been effected manually. Accordingly, the present invention fosters a reduction in handling of bare optical fiber, and as such improves safety in workplace. Moreover, the present invention fosters cleanliness of the prepared fiber end. The present invention also results in a reduction in time required to prepare a fiber for cleaving and of the cleaving thereof. Moreover, the cleave achieved in accordance with an exemplary embodiment of the present invention results in an endface having an accurate angle with respect to the optic axis; and one having substantially few aberrations or fractures resulting from the cleave. Illustratively, the cleaved optical fiber may then be fused by a variety of techniques to another optical fiber, another optical waveguide, or another optical device including an integrated optical waveguide or silicon optical bench. The better cleave results in a better fusion of the optical fiber to another optical fiber, optical waveguide or other optical device. This results ultimately in better coupling, and better optical performance by the optical fiber cleaved in accordance with an exemplary embodiment of the present invention.

While the preparation of the optical fiber for cleaving and the cleaving thereof is useful for fusion splicing of an optical fiber as described above, the cleaved fiber may be mechanically spliced where optical adhesives are used to provide the mechanical bond between the optical fiber, another optical fiber or other optical devices as referenced above. Moreover, the preparation for cleaving and cleaving of the optical fiber in accordance with an exemplary embodiment of the present invention may be useful in effecting power meter measurements, optical measurements (e.g. polarization mode dispersion measurements) and other measurements within the purview of one having ordinary skill in the art. Additionally, the optical fiber which has been prepared for cleaving and cleaved in accordance with the illustrative embodiments of the present invention may be useful in mechanical measurements (e.g. core-cladding concentricity measurements), optical time domain reflectometry (OTDR) connections. Furthermore, the fibers prepared for cleaving and cleaved in accordance with exemplary embodiments of the present invention may have ends used for optical switches, particularly large quantity optical fiber switches. Finally, the cleaning sequence in accordance with an exemplary embodiment of the present invention results in better contaminant removal then is conventionally achieved. Removal of contaminants ultimately results in better optical coupling in various applications of optical fibers prepared in accordance with illustrative embodiments of the present invention. These and other advantages will be readily apparent to one having ordinary skill in the art having had the benefit of the present disclosure. Still other advantages may be realized through use of the present invention.

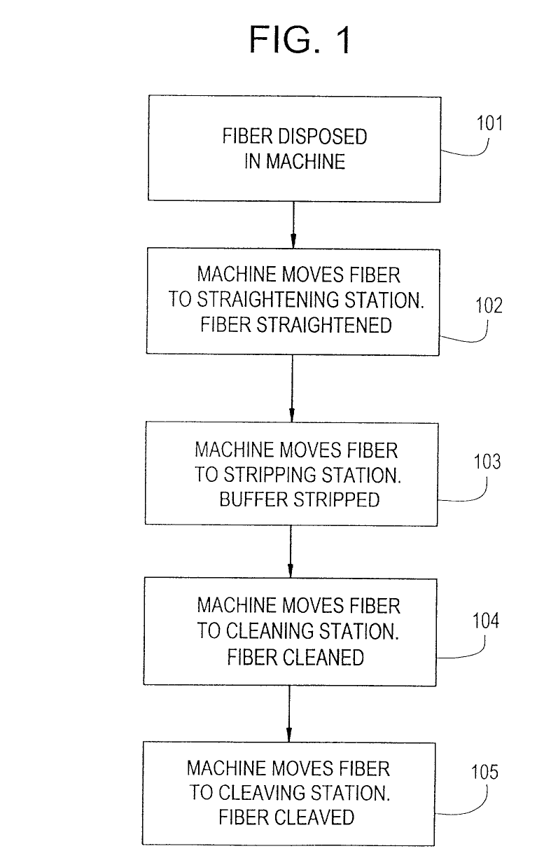

Turning to FIG. 1, an illustrative method of cleaving an optical fiber is shown via a flow chart. Illustratively, the method of FIG. 1 may be implemented using fiber preparation machines such as those described hereinbelow. Alternatively, the illustrative method described in FIG. 1 may be implemented using other fiber preparation machines. At 101, the optical fiber is disposed in the machine. The optical fiber illustratively has a random length. Next, at 102, the machine moves the optical fiber to a straightening station, where the optical fiber is straightened. The straightening of the optical fiber is effected to remove curling of the optical fiber by coating set. This curling may be severe, and is usefully eliminated to allow the fiber to be cut at a prescribed and constant length. This facilitates the described preparation sequence, and ultimately assures improved optical coupling in various applications of the optical fiber such as fusion splicing to another optical fiber, optical waveguide or optical device. It is noted that the optical fiber may be cut to a predetermined length at the straightening station. The cutting of the optical fiber to a particular length has advantages described herein.

Next, as shown at 103, the machine moves the optical fiber to a stripper station, where the buffer (or coating) is stripped. Because the optical fiber has been straightened in the straightening sequence as described in 102, the removal of the buffer to a predetermined and substantially constant length can be readily achieved. Next, as shown at 104, the machine moves the fiber to a cleaning station, where the optical fiber is cleaned. This cleaning step removes any debris and/or contaminants which may have remained after the stripping or which may have been disposed on the fiber during the prior processing sequences described above. The removal of these debris and/or contaminants is beneficial to assuring proper coupling when the optical fiber is fused to another optical fiber, optical waveguide or optical device. Next, as shown at 105, the machine moves the optical fiber to a cleaving station, where the fiber is cleaved at a precise endface angle (e.g. the endface angle is perpendicular to the optic axis). Illustratively, the optical fiber is tensioned accurately, to avoid the occurrence of too great or too little tension on the optical fiber. This assures a good clean cleave of the fiber, resulting in a substantially defect-free endface. Finally, it is of interest to note that the above sequence may include a carbon pre-burn, which may be carried out after stripping of the buffer layer(s). The carbon pre-burn tends to increase electrode life and decrease variability associated with the splicing of erbium fibers, commonly used as a gain medium in a variety of optical applications.

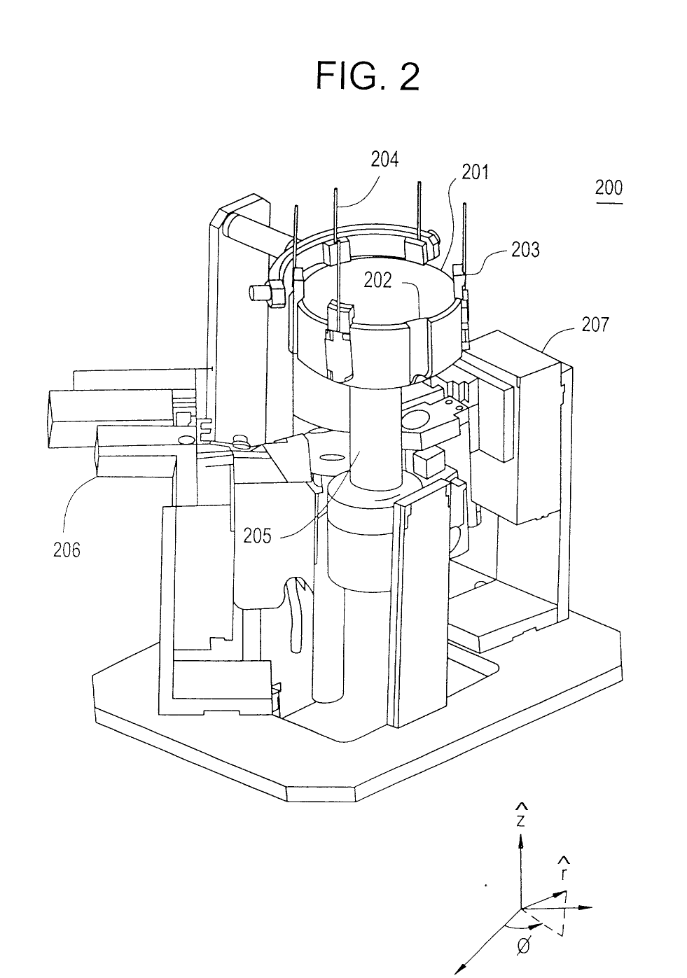

FIG. 2 is a perspective view of a fiber preparation machine 200 in accordance with an illustrative embodiment of the present invention. The fiber preparation machine 200 includes a fiber holder transport 201. The fiber holder transport 201 has pockets 202 which receive optical fiber holders 203 having optical fibers 204 disposed therein. It is noted that the optical fibers are oriented substantially vertically. The vertical orientation is advantageous at various stations of the fiber preparation machine (and processing thereby) according to illustrative embodiments of the present invention. Further details will be described below. The fiber holder transport 201 is illustratively a cylindrical element such as a rotary drum, which rotates about a shaft 205 that may be actuated by a servo motor. Alternatively, the shaft 205 may be actuated by a pneumatic acutator, a rotational piezoelectric device, or a gear driven mechanism. The servo motor or other device may be controlled by a microcomputer or suitable controller (not shown). Of course, software would be implemented to support the fiber preparation sequence.

The fiber preparation machine 200 includes a fiber straightening station (not shown in FIG. 2) that substantially straightens the fibers; a fiber stripping station 206 that removes a portion of the buffer; a cleaning station (not readily visible in FIG. 2); and a cleaving station 207.

In the illustrative embodiment shown in FIG. 2, the fiber preparation machine 200 has the ability to sequentially process six optical fibers 204. Of course, this is merely illustrative, and other number of optical fibers may be processed sequentially, resulting ultimately in a cleaved optical fiber in accordance with an illustrative embodiment of the present invention. Moreover, in the illustrative embodiment shown in FIG. 2, the fiber holder transport 201 rotationally transfers each optical fiber using the substantially cylindrical fiber holder transport 201. This is also merely illustrative, and the fiber holder transport 201 can be an element of a variety of other shapes adapted to rotationally transfer the optical fibers 204 from one station of fiber preparation machine 200 to the next. It is further noted that rotational motion of the optical fibers from one station to another is also merely illustrative, and the optical fibers may be transferred from one station to the next by other types of motion. For example, the optical fibers may be moved linearly from one station to the next. The fibers may also be moved linearly to a first station, effect a turn of predetermined angle, and move linearly to a next station. Some examples of alternative fiber holder transports and motion of optical fibers thereby are described below. Still other fiber holder transports and motion of fibers thereby are possible, as will be apparent to one having ordinary skill in the art having had the benefit of the present disclosure.

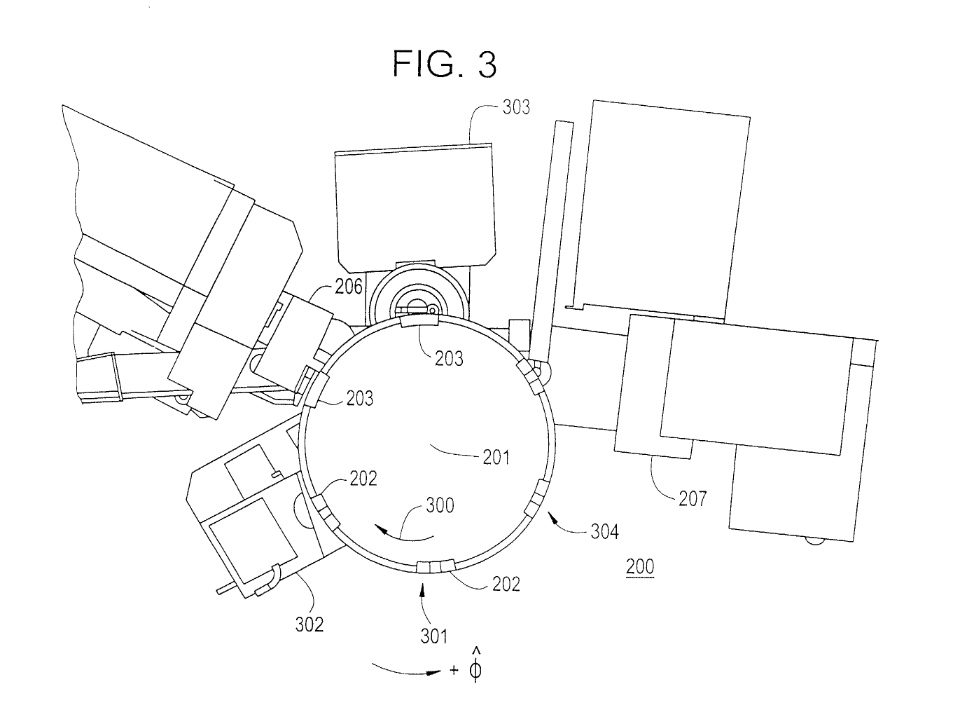

Turning to FIG. 3, a top view of an illustrative fiber preparation machine is shown in top view. The fiber holder transport 201 is shown to rotate in a clock-wise direction 300. Each fiber will sequence via the rotation to its next station where a respective process is carried out. The particular details of each process sequence and the various details of the elements thereof will be described in further detail herein. Presently, an overview of an exemplary processing sequence is described. The optical fiber, having a substantially vertical orientation, is disposed in a fiber holder 203. The fiber holder 203 is disposed in the pocket 202 at a loading station 301. The fiber holder transport 201 rotates in a clock-wise direction 300 to the first station, illustratively a fiber straightening station 302. At the fiber straightening station 302, the fiber is straightened and processed as described in further herein. Upon completion at the fiber straightening station 302, the fiber holder transport 201 rotates to the next station, illustratively stripping station 206. At the stripping station 206, a predetermine length of buffer layer is removed. After completion at the stripping station 206, the fiber holder transport 201 rotates the optical fiber to the next station, illustratively cleaning station 303. At the cleaning station 303, debris and contaminants are removed from the fiber. After completion at the cleaning station 303, the fiber holder transport 201 rotates to the next station, illustratively the cleaving station 207. The optical fiber is then tensioned by a predetermined amount, and the fiber is cleaved. This completes the illustrative preparation sequence. The optical fiber then rotates in the sequence to a final position 304 where the fiber in the fiber holder 203 is removed.

It is noted that the fiber preparation sequence and apparatus described is merely an illustrative embodiment of the present invention. Clearly, additional fiber processing stations, which perform the same or different functions, could be added to the sequence. Moreover, if desired, fewer fiber preparation stations could be included.

Advantageously, the illustrative fiber preparation machine 200 and process enable the optical fibers to be cleaved in an efficient process, with each station performing its respective function sequentially on a member of fibers. By virtue of the present invention, the fibers are substantially straight, cut to a predetermined length, and have endfaces which are substantially defect and contaminant free. Moreover, the endfaces form an angle with the optic axis which is accurate. Further details of the above referenced advantages are described herein.

Another advantage of the fiber preparation machine 200 in accordance with the illustrative embodiment is the ability to process a plurality of fibers concurrently in a substantially automated manner. An example of the simultaneous processing is described presently. Two optical fibers 204 in fiber holders 203 are disposed in pockets 202 at loading stations 301 and 304. The fiber holder transport 201 rotates clockwise bringing the first fiber to the straightening station 302. The first fiber is straightened. Upon completion of the straightening step, fiber holder transport 201 rotates clockwise bringing the first fiber to the stripping station 206 and the second fiber to the straightening station 302. The first fiber is stripped of its buffer in stripping station 206 concurrently with the straightening of the fiber in straightening station 302. When both steps are complete, the fiber holder transport 201 rotates clockwise again bringing the first fiber to the cleaning 303 and the second fiber to the stripping station 206. While the first fiber is cleaned, the second fiber is stripped of its buffer. Once the cleaning station 303 and the stripping station 206 have completed their cycles, the fiber holder transport 201 rotates yet again to locate the first fiber at the cleaving station 207 and the second fiber at the cleaning station 303. While the first fiber is cleaved in the cleaving station 207, the second fiber is cleaned. After both steps are completed, the fiber holder transport 201 rotates to bring the first fiber to unload station 304 and the second fiber to the cleaving station 207. At this point, the first fiber may be unloaded. The second fiber is cleaved, and the processing of further fibers may continue concurrently and in a substantially automated manner.

It is again noted that the number and types of fiber processing stations is merely illustrative. Accordingly, other types as well as more or fewer fiber processing stations are clearly envisioned in accordance with the present invention.

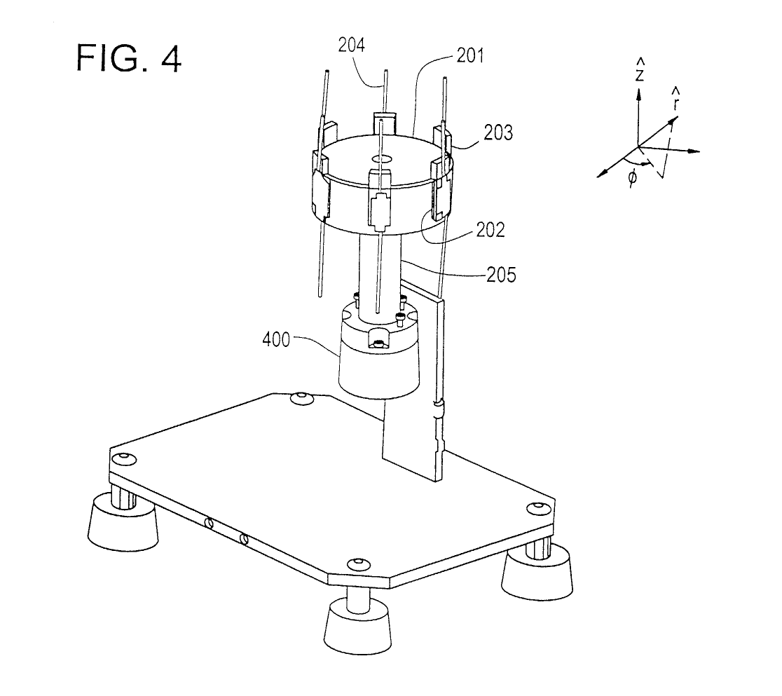

Turning to FIG. 4, a perspective view of the fiber holder transport 201, rotational shaft 205, and servo motor 400 is shown. Optical fibers 204 are held in fiber holders 203 which are disposed in pockets 202. The illustrative servo motor 400 enables rotation of the fiber holder transport 201 in the −φ direction according to the cylindrical coordinate system shown in FIG. 4. Illustratively, the rotation is a step rotation. This enables rotation discretely from one station to the next upon completion of a prescribed process at a particular station. An actuator (not shown) may be included to the servo motor 400 to enable motion in the ±z-direction. This would enable the optical fibers 204 to be raised and lowered into and out of various elements of the stations. However, in the illustrative embodiment the individual stations are adapted to elevate and lower to perform respective operations on the fibers 204. Accordingly, the fiber holder transport 201 rotates in sequential steps from one station to the next; and the station raises, performs its function and lowers to its original position. The fiber holder transport 201 then rotates the fiber to the next station and another fiber to the station just lowered.

As referenced above, the motion of the fiber holder transport 201 may be actuated by servo motor 400, an actuator, or other device. In any case, the servo motor 400 (or like device) may be controlled by a microcontroller well known to one having ordinary skill in the art. Illustratively, the microcontroller for the servo motor 400 also controls the motion of all other actuators of the fiber preparation machine 200. Alternatively, other controller schemes could be employed, provided a coordinating controller is used.

It is noted that the substantial cylindrical shape of the fiber holder transport 201 is merely illustrative. To wit, other shapes may be used for the fiber holder transport. Illustratively, the chosen shape of the fiber holder transport 201 will enable rotation about an axis so that the optical fibers may move from one station to the next in the fiber preparation machine. For example, a variety of polygons may be used, as would be readily apparent to one having ordinary skill in the art.

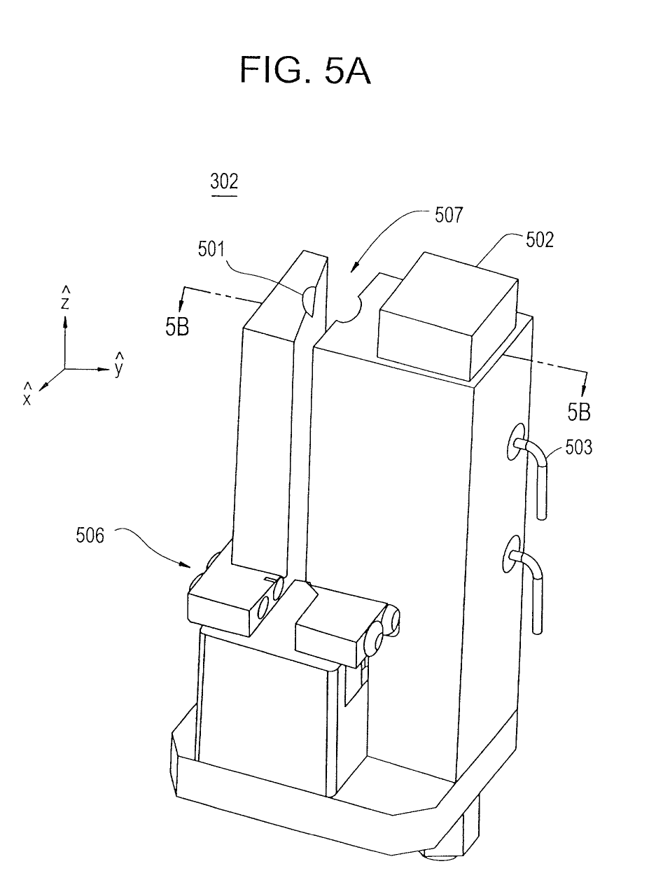

Turning to FIGS. 5(a) and 5(b), a perspective and cross-sectional view of the fiber straightening station 302 are shown, respectively. The optical fiber has a substantially vertical orientation (z-direction in FIG. 5(a) and FIG. 5(b)). The optical fiber sequences by rotation of the optical fiber from the loading station (shown at 301 in FIG. 3) to the fiber straightening station. The fiber straightening station 302 rises in the +z-direction to lower the fiber into the lead-in 501. Alternatively, the optical fiber may be lowered by the motion of the fiber holder transport (e.g. fiber holder transport 201 in FIG. 2) in the −z-direction into the lead-in. Another alternative is that fiber enters the fiber straightening 302 via the rotational lead-in 507 as fiber holder transport 201 rotates clockwise. A fiber holder sensor 502 detects the presence of a fiber holder (e.g. fiber holder 203 shown in FIG. 2). This serves as input to the controller. This allows for efficient operation of the fiber preparation machine as empty pockets (e.g. pocket 202 in FIG. 2) need not be processed.

Cartridge heaters 503 are useful in heating the optical fiber. To this end, as shown in FIG. 5(b), the cartridge heaters 503 act in cooperation with process gas cross channels 504 to introduce heated, moving gas into a heating chamber 505. The cartridge heaters 503 warm heater block 509. Heater block 509 is made of a material that enables thermal conduction to transfer heat to the gas cross-channels 504 and the gas inlet-channel 508, where the gas is warmed by convection. When an optical fiber is lowered into the heating chamber 505 via lead-in 501 or 507, the heated gas flowing into heating chamber 505 warms the fiber via convection thus softening its buffer layers. It is noted that the fiber straightening station 302 as described is merely illustrative, and may include other heating mechanisms. For example, the fiber could be scanned with heating gas. The fiber could be held in a hot zone and heated by radiative heating. The fiber could also be contacted by a heated surface and conductively heated.

Once the buffer layers are softened sufficiently, substantially all of the set is relieved and the fiber returns to the natural shape of the glass, which typically is very straight. The vertical orientation allows the fiber to be easily guided through the lead-ins. The cutting blades 506 usefully cut the length of the optical fiber to a prescribed length. As can be readily appreciated, this length is relatively constant for all fibers processed by the fiber preparation machine 200 and eases the task of guiding the fiber between stations and within each station.

The fiber straightening station 302 is particularly useful in substantially removing curl caused by setting of the buffer layer. Optical fibers are conventionally shipped in coiled form, and over time, the fibers can become curled due to the setting of the buffer layer. The fiber straightening station 302 is useful in removing this curl. Moreover, the vertical orientation of the fiber can help to eliminate the distortive effects of gravity upon fiber shape in this, previous, and subsequent steps of the fiber preparation process according to illustrative embodiments of the present invention. Finally, the cut to length feature in fiber straightening station 302 also has the advantage that the scrap fiber can be collected by the machine and/or transported to a waste collection bin. Vertical orientation allows gravity to assist in waste removal.

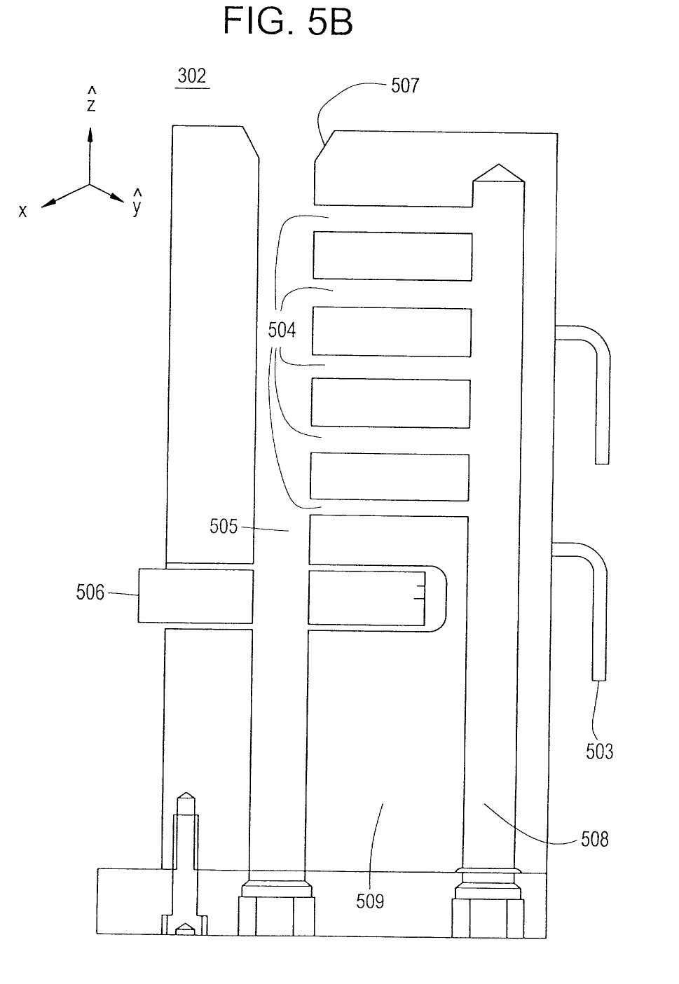

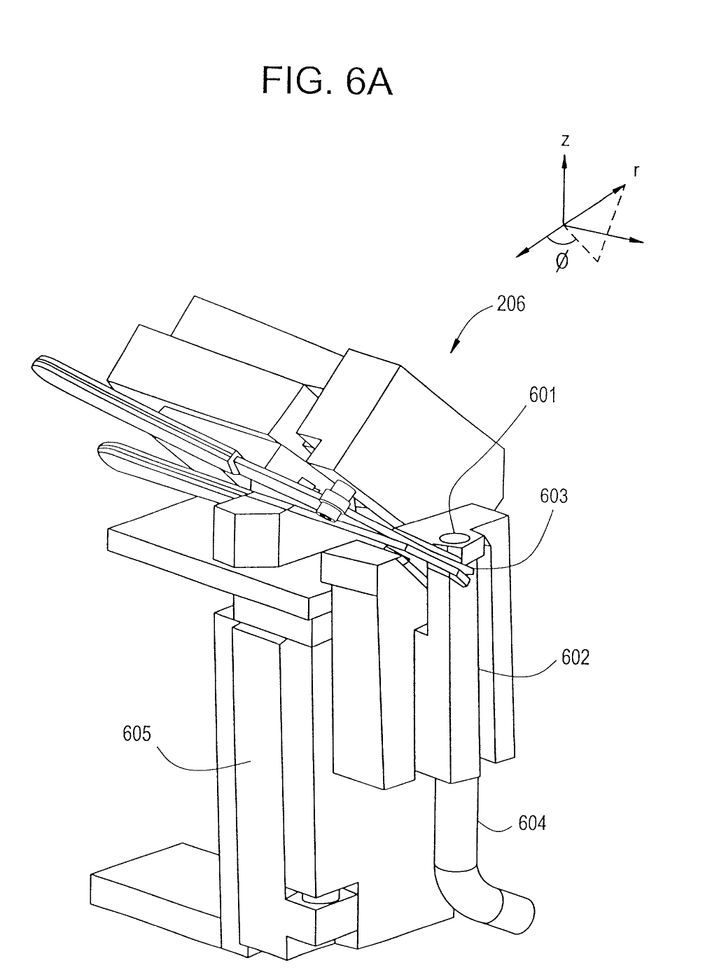

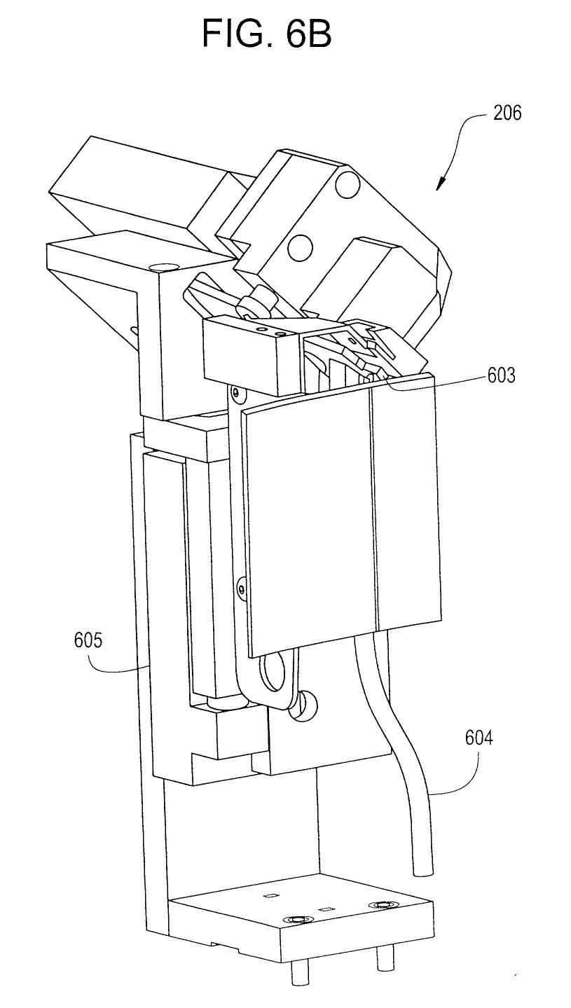

Upon completion at the fiber straightening station 302, the fiber holder transport 201 moves the fiber in the −φ direction (as shown in FIG. 2). The fiber is rotated in this discrete rotational step to the next station, the fiber stripping station 206. The fiber stripping station 206 is shown in FIG. 6(a) in a detailed perspective view described presently. The fiber stripping station 206 moves in the +z-direction so the fiber (not shown in FIG. 6(a)) is inserted into the lead-in 601. Alternatively, the fiber holder transport could lower the optical fiber into the lead-in 601 via motion in −z-direction. As can be appreciated, gravity aids in guiding the fiber due to the vertical orientation of the fiber stripping station 206. The optical fiber passes between stripper blades 603 and enters a heated tube 602. At the bottom of the heated tube is a vacuum take-away 604. The heated tube and air within are generally heated sufficiently to soften the buffer layer.

The stripper blades 603 cut into the buffer layer of the optical fiber peripherally. Illustratively, a pneumatic cylinder 605 lowers the heated tube 603 and stripper blades 603 in the −z-direction, while the fiber 204 remains substantially fixed. Thereby, the buffer layer of the optical fiber is removed. The vacuum take-away 604 discards the removed buffer layer and substantially all other debris of this particular process.

Alternatively, the buffer may be removed as follows upon insertion of the fiber into the heated tube 602, hot gases assist in removing the buffer material from the optical fiber. The gases are in the form of a jet or stream and are directed onto that portion of the coating material of the buffer material that is to be removed. The gases are of a composition that substantially does not react with the material of the buffer layer. Moreover, the temperature of the gas is sufficiently high that is softens the buffer layer. Further details of the use of hot gases may be found in U.S. Pat. No. 5,948,202 to Miller The patent to Miller is specifically incorporated by reference herein in its entirety and for all purposes.

It is noted that the stripping station 206 is illustrative, and may include other stripping mechanisms. For example, other mechanical strippers known to one of ordinary skill in the art may be used. Moreover, a hot nitrogen strip, again known in the art may be used.

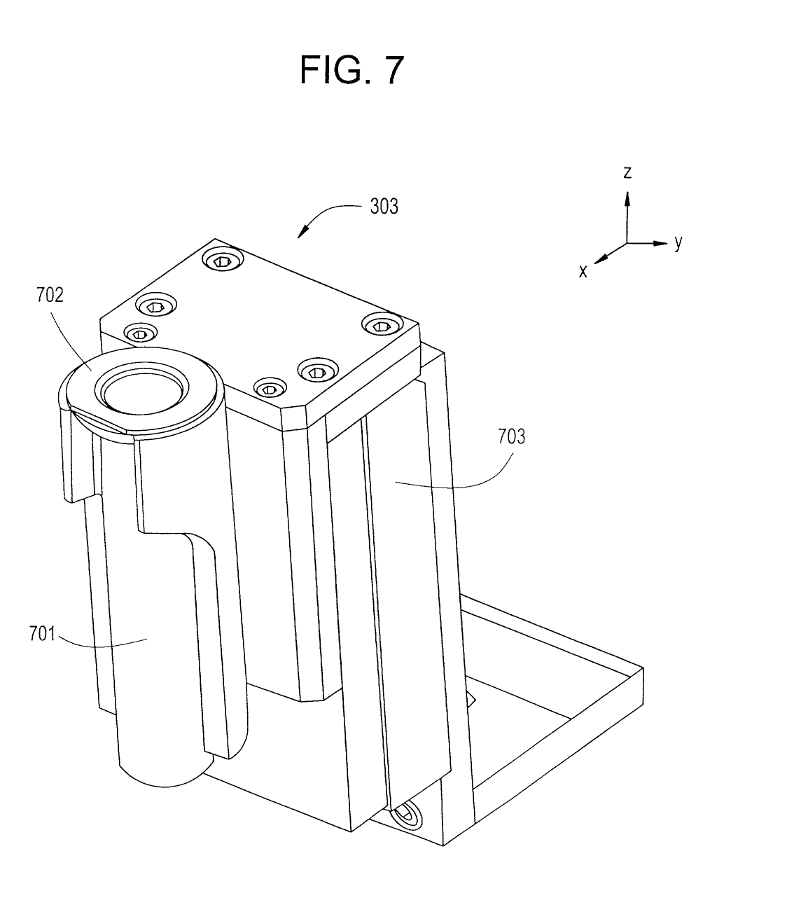

Upon removal of the buffer layer at the stripping station 206, the optical fiber is moved to the cleaning station (shown at 303 in FIG. 3). Again, this is effected through motion rotation in the −φ (see cylindrical coordinate system of FIG. 2, for example) of the fiber holder transport. Turning to FIG. 7, the cleaning station 303 is shown in a detailed perspective view. The cleaning station 303 includes a bath 701, and a fiber lead-in 702. A pneumatic cylinder 703 raises the bath 701 in the +z-direction, thus submerging the optical fiber into the cylinder bath via the lead-in 702. Alternatively, the fiber holder transport 201 could move the fiber 204 in the −z-direction into the bath 702. Illustratively, the bath 701 is an ultrasonic alcohol bath.

Again, the optical fiber is oriented in the vertical direction (z-direction in the Cartesian coordinate system shown in FIG. 7) in the bath 701. The lead-in 702 has a substantially conical opening as shown. This facilitates insertion of the optical fiber into the cylinder bath 701. Because the optical fiber is oriented vertically, there is little chance the optical fiber will contact a surface of the bath 701, which may be adapted to vibrate. Ultimately, this substantially prevents degradation of the fiber strength, which can result if the fiber comes in contact with the vibrating surface used in the ultrasonic cleaning sequence presently described. In addition to aiding in fiber guidance at the cleaning station 303, the vertical orientation allows passive handling of any cleaning fluid utilized. The fluid can remain in the tank between fibers. Also, solids removed from the processed fibers can sink to the bottom of the tank if the cleaning fluid has lower mass density than the contaminant particles.

It is noted that the described cleaning method of cleaning station 303 is illustrative and other cleaning methods are possible. For example, the fibers could be cleaned with pads wetted with a suitable cleaner. The pads would moves vertically over the fiber by virtue of the motion of the cleaning station 303.

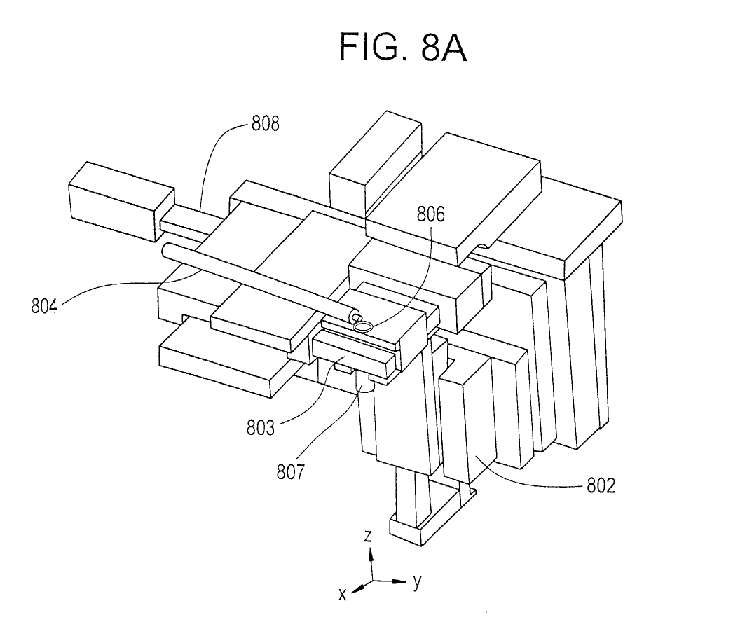

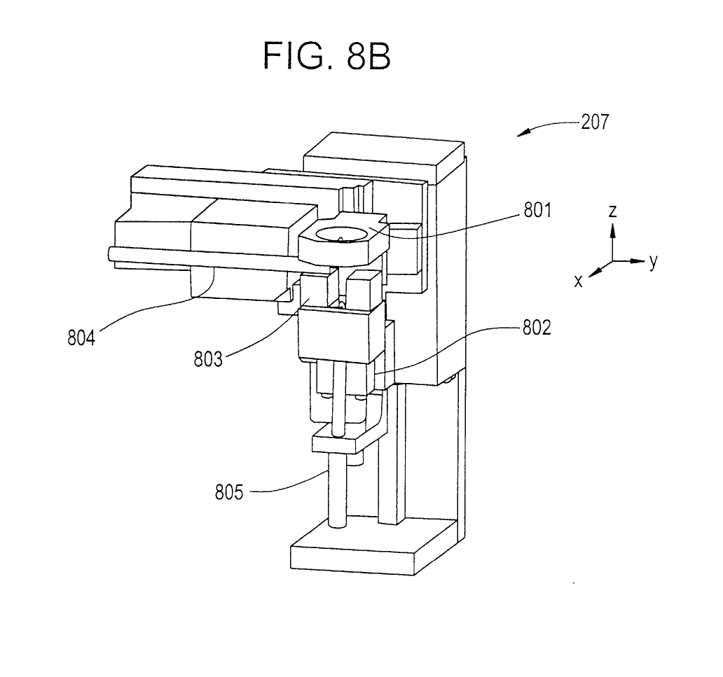

Upon completion at the cleaning station 303, the fiber holder indexes through rotational motion in the −φ-direction (reference FIG. 2) to the cleaving station 207 shown in FIG. 8(a). The optical fiber is vertically oriented (z-direction) and is disposed in upper lead-in 806 down through to a lower lead-in 807. The upper lead-in 806 and lower lead-in 807 position the fiber accurately relative to a cleaver horn, illustratively an ultrasonic cleaver horn 804, for cleaving. A tensioning slide 802 applies a substantially dead-weight tension, and the ultrasonic horn 804 is positioned by a servo motor and stage 808. The substantially dead-weight tension applied to the optical fiber via the tensioning slide 802 is nearly constant. To this end, the tensioning slide 802 moves on a substantially low-friction slide, and applies a nearly constant tension that is set in a particular range of force. For example, for a 250 μm diameter optical fiber, a tensile force in the range of approximately 170 g to approximately 250 g is applied by the tensioning slide 802. When the optical fiber is properly tensioned, the ultrasonic horn 804 cleaves the fiber by well-known techniques. Upon completion of the cleaving, fiber grippers 803 release the cleaved portion of the optical fiber. A vacuum take-away removes the cleaved portion of the fiber, and the fiber is removed from the upper lead-in 806. The vacuum take-away is particularly advantageous from the perspective of safety as small sharp pieces of optical fiber due not need to be manually discarded by the operator.

Because the tension on the optical fiber is set at a particular level and substantially maintained at this level, the problems associated of with having inconsistent tension during cleaving, as well as tension which is too great or too little tension during the cleaving process, are substantially avoided. Ultimately, this fosters the ability to cleave the optical fiber at an accurate angle relative to the endface, and to provide a clean endface with minimal aberrations and/or fractures. Moreover, the method in accordance with an illustrative embodiment of the present invention results in fiber ends with negligible amounts of hackle, negligible incidence of chips, negligible incidence of lips, and negligible incidence of spirals. The area of the endface affected by mist is small. The area of the score mark on the endface is also small. It is further noted that in the illustrative embodiment described, the speed and position of the blade are useful in assuring the accuracy and quality of the cleave.

Another illustrative embodiment of the fiber cleaving station 207 is shown in a detailed perspective view in FIG. 8(b). In this illustrative embodiment, the optical fiber is inserted into fiber grippers 803 via lead-in 801. Again, tensioning slide 802 applies a substantially dead-weight tension to the optical fiber, which is again vertically oriented (z-direction). When the optical fiber is properly tension, the ultrasonic horn 804 cleaves the fiber. Upon completion of the cleaving, the fiber grippers 803 release the cleaved lower portion of the optical fiber. Next, a vacuum take-away 805 removes the cleaved portion of the fiber and fiber is removed from the upper lead-in 801.

In the illustrative stations described above, the cleaving mechanism is an ultrasonic cleaver horn. Of course, this is merely illustrative, and other cleaving mechanisms may be used to effectively cleave the optical fiber in accordance with the present invention. Generally, a flaw inducer is moved at a controlled speed and position to effectively cleave the optical fiber. The flaw inducer may be an ultrasonically agitated sharp edge, such as the ultrasonic cleaver horn described above. The flaw inducer may move via a servo motor and warm gear. Additionally, the flaw inducer may move via a rotational piezo electric motor. Furthermore, other types of flaw inducers within the purview of one having ordinary skill in the art may be used in this capacity as well.

Finally, upon completion at cleaving station 207, the fiber holder transport 201 rotates in the −φ direction (reference FIGS. 2 and 3) to its final position 304, where the optical fiber holder 203 is removed from the fiber holder transport 201. The optical fiber may then be further processed. The further processing may include fusion of the optical fiber to another optical fiber, an optical wavguide, or an optical device; or another process referenced above.

The above described method is merely an illustrative method for cleaving an optical fiber in accordance with an exemplary embodiment of the present invention. Of course, other methods may be implemented using a machine in accordance with an illustrative embodiment of the present invention. Two such illustrative methods are described in the below examples. These are merely illustrative of the present invention, and of course, still further techniques may be used.

### Fiber Preparation Sequence Examples

### Illustrative Method I

Operator loads fiber into clips.

Operator loads clips into magazine (up to 3).

Operator hits START button.

### Heat Straightening Module

Cylinder rises.

Heated gas blows onto fiber.

Fiber straightens by glass stiffness and gravity once coating softens.

Cylinder lowers.

Heated gas blows onto fiber.

Fiber straightens by glass stiffness and gravity once coating softens.

Magazine indexes one station.

First fiber moves to Stripping station (2^{nd} fiber moves into HSM concurrently, etc.)

### Stripping Station

Cut to length is actuated.

Hook shears excess fiber off.

Hook continues to pull fiber and fiber is aligned over stripper.

Stripping module rises.

Fiber passes between stripper blades into heated vacuum tube

Heated tube softens coating.

Stripper closes around fiber.

Stripping module descends.

Coating is removed from fiber.

Vacuum sucks coating debris away to central collection bin.

Magazine indexes one station.

### Cleaning Station

Cleaning module rises

Fiber enters alcohol bath.

Ultrasonic vibrations begin.

Cleaning module descends.

Ultrasonic vibrations cease.

Magazine indexes one station.

### Cleaver Station

Cleaver module rises.

Conical lead-in captures fiber.

Fiber passes through lower conical lead-in into vacuum take-away tube.

Gripper closes onto fiber.

Tensioning cylinder is actuated.

Deadweight applies downward force upon the gripper.

Fiber is tensioned.

Cleaver drive starts moving blade towards fiber.

Ultrasonic vibrations begin.

Cleaver drive continues moving.

Blade contacts fiber.

Fiber is cleaved through.

Gripper (with scrap end) on tensioning slide drops via gravity.

Ultrasonic vibrations end (by timer).

Cleaver drive retracts blade/Gripper opens (scrap end removed by vacuum)/Cleaver module descends.

Magazine indexes one station.

Operator unloads cleaved fiber end(s).

### Illustrative Method II

Operator loads fiber into clips.

Operator loads clips into magazine (up to 3).

Operator hits START button.

### Heat Straightening Module

Process gas flow is started (blows heated gas onto fiber in HSM).

Fiber straightens by glass stiffness and gravity once coating softens.

Fiber is cut to length.

Magazine indexes one station.

First fiber moves to Stripping station (2^{nd} fiber moves into HSM concurrently, etc.).

Clip sensor signals controller when first load station (heat straightening module) is loaded.

### Stripping Station

Stripping module rises.

Conical lead-in captures fiber.

Fiber passes through stripper and into heated (or unheated) vacuum tube.

Heated tube softens coating.

Stripper engages fiber.

Stripping module descends.

Coating is removed from fiber.

Vacuum sucks coating debris away to central collection bin.

Magazine indexes one station.

### Cleaning Station

Cleaning module rises

Fiber enters alcohol bath.

Ultrasonic vibrations begin.

Cleaning module descends.

Ultrasonic vibrations cease.

Magazine indexes one station.

### Cleaver Station

Cleaver module rises.

Conical lead-in captures fiber.

Fiber passes through lower conical lead-in into vacuum take-away tube.

Gripper closes on fiber to hold it.

Tensioning cylinder is actuated.

Deadweight applies downward force upon the gripper.

Fiber is tensioned.

Cleaver drive starts moving blade towards fiber.

Ultrasonic vibrations begin (if using ultrasonic cleaver).

Cleaver drive continues moving.

Blade contacts fiber.

Fiber is cleaved through.

Gripper (with scrap end) on tensioning slide drops via gravity.

Ultrasonic vibrations end (by timer).

Cleaver drive retracts blade/Gripper opens (scrap end removed by vacuum)/Cleaver module descends.

Magazine indexes one station

Operator unloads cleaved fiber end(s).

To this point, in the illustrative apparati described the entire fiber holder transport is moved (e.g. rotationally) and thereby the optical fibers are transported from one station to the next for processing. This is merely illustrative. Accordingly, other apparati may be used may be used to effect the transport of the fibers from one station to the next. In the illustrative examples that follow, various alternative fiber transport mechanisms are disclosed. Again, these are merely illustrative, and other fiber transport mechanisms may be employed. Finally, it is noted that the methods described in the illustrative embodiments above apply to the fiber transport mechanisms described herein. To wit, the fiber transport mechanisms which enable the transportation of the fiber from one station described presently to the next may all benefit from the illustrative methods and stations described above.

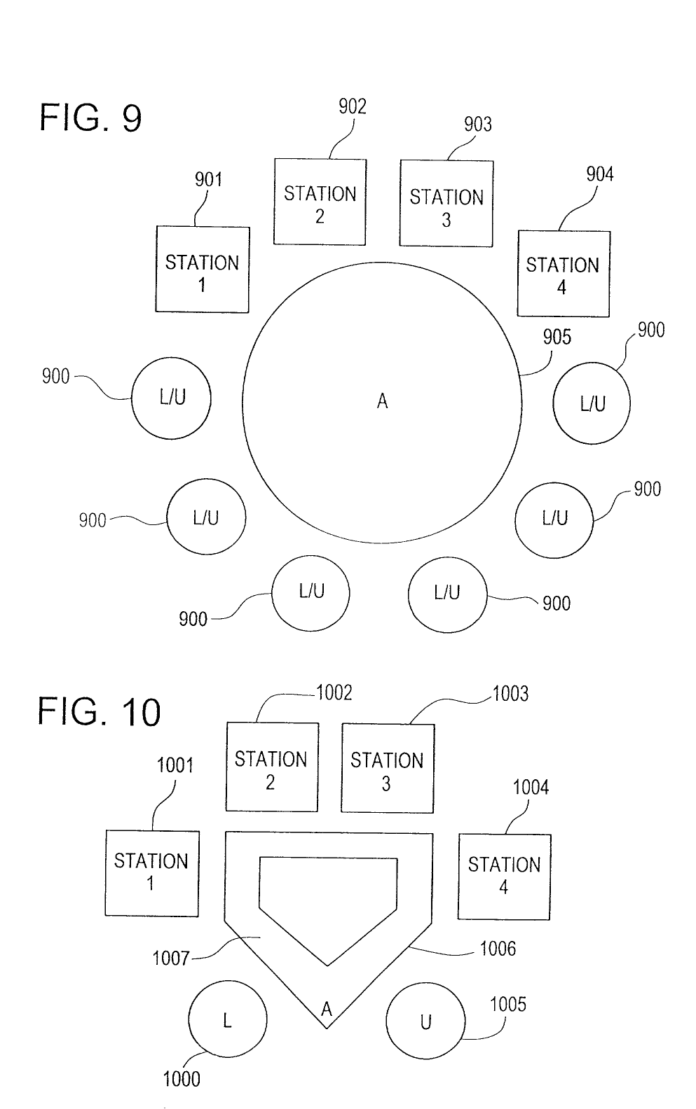

FIG. 9 is a functional block diagram of an illustrative fiber preparation machine in accordance with an exemplary embodiment of the present invention. The optical fibers may be loaded and unloaded at load/unload (L/U) stations 900. The fiber holder transport 905 illustratively includes a track or similar transport mechanism (not shown) in which the optical fiber holders 203 would be disposed. The optical fibers would then rotate in a clockwise manner proceeding to station 1 (901), station 2 (902), station 3 (903), station 4 (904) and finally to one of the load/unload stations 900 for removal and preparation. For purposes of illustration, station 1 (901) is a fiber straightening station as described above; station 2 (902) is a fiber stripping station as described above; station 3 (903) is a fiber cleaning station as described above; and station 4 (904) is a fiber cleaving station, also as described above. As can be readily appreciated, a noteworthy difference between the fiber preparation machine of the illustrative embodiment of FIG. 9 and those described above is the fiber holder transport 905 does not move, but rather has elements contained therein which do. Moreover, a large number of load/unload stations 900 may be used.

FIG. 10 shows another illustrative embodiment in accordance with the present invention. Again, an optical fiber would be loaded at loading station 1000, and would proceed to station 1 (1001), station 2 (1002), station 3 (1003), station 4 (1004), and finally to unload station 1005. The fiber holder transport 1006 is illustratively pentagonally shaped. The fiber holder transport again includes a track 1007 in which the optical fibers are guided from one station to the next. Moreover, the stations described in connection with the illustrative embodiment of FIG. 9 are the same as those in FIG. 10. Again, a significant difference between the illustrative embodiment shown in FIG. 10 and those described previously, lies in the stationary nature of the fiber holder transport. To this end, the fiber holder transport remains substantially stationary, but includes a mechanism therein which enables the motion of the optical fibers from one station to another. It is noted that the optical fibers may be held within modules which are transported via the track 1007 from one station to the next. It is further noted that the motion of the optical fibers (and modules if used) is effected by known devices. Finally, it is noted that the pentagonal shape is merely illustrative, and other polygonal may be used.

Turning to FIG. 11, another illustrative embodiment of the present invention is shown. In the present illustrative embodiment, optical fibers are loaded at load station 1100 and are transported from station 1 (1101), to station 2 (1102), to station 3 (1103), to station 4 (1104), and to unload station 5 (1105). The fiber holder transport 1106 is substantially linear, and has tracks or other suitable devices to effect the motion of the optical fibers down the length of the fiber holder transport enabling motion from stations 1-4.

FIG. 12 shows another illustrative embodiment, which is similar to that shown in FIG. 11. The loading station is combined with station 1 to form loading/station 1 (1201). Similarly, the unload station and station 4 are also combined to form station 4/unload station 1204. Stations 2 and 3 remain substantially identical to their counter parts in the illustrative embodiment of FIG. 5. Moreover, the fiber holder transport 1205 is substantially identical to that described in connection with FIG. 11.

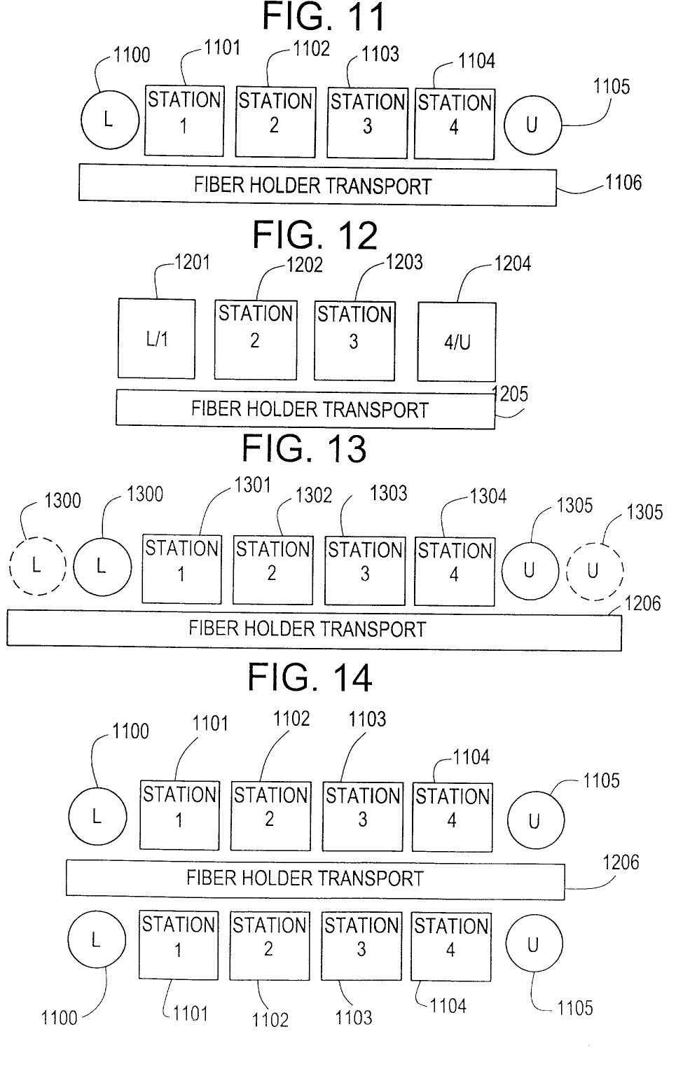

Turning to FIG. 13, a linear fiber preparation machine is shown. In the illustrative embodiment in FIG. 13, there are two load stations 1300 and two unloads stations 1305. The fiber holder transport 1206 again includes a track or other suitable device to provide motion of the optical fibers from stations 1-4, 1301-1304, respectively. Of course, a larger number of load stations 1300 and unload stations 1305 that that shown may be used.

Turning to FIG. 14, yet another illustrative embodiment of the present invention is shown. The illustrative embodiment shown in FIG. 14 is substantially identical to that shown in FIG. 11, however, as can be readily appreciated, there are identical stations 1100-1105 on either side of the fiber holder transport 1106. Accordingly, fibers are loaded along two tracks, or other similar devices, enabling processing of twice as many optical fibers simultaneously as is possible with the illustrative embodiment of FIG. 11. Alternatively, if a station takes a longer duration to complete than another, two stations may be deployed to receive output from a single station 3 (1103).

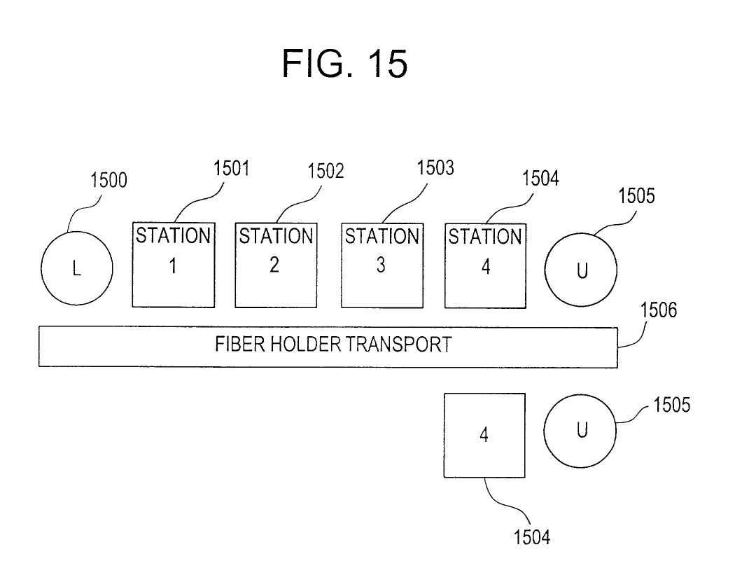

Turning to FIG. 15, an illustrative embodiment is shown where only certain stations are present in multiples. For example, in the embodiment shown in FIG. 15, station 4 (1504) is duplicative as is the unload station 1505. The load station 1500, station 1 (1501), station 2 (1502), station 3 (1503), and fiber holder transport 1506 are as described in the above illustrative embodiments, for example the illustrative embodiment of FIG. 14. With the present illustrative embodiment, a fiber starts at load station 1500, progresses through station 1 (1501), station 2 (1502) and station 3 (1503). The fiber can be processed and either of the two stations 4 (1504). The fiber holder transport 1506 moves the fiber to the first available station 4. This is particularly a beneficial embodiment if the cycle time for station 4 is long than the cycle time required to complete the processing steps at station 1, station 2 and station 3. Of course, this is merely illustrative, and the principle briefly described in connection with FIG. 15 can be expanded to include other and more processing stations as would readily apparent to one having ordinary skill in the art.

The invention being thus described, it would be obvious that the same may be varied in many ways by one of ordinary skill in the art having had the benefit of the present disclosure. For example, it is noted that the fiber preparation stations described above are merely illustrative. To this end, more or fewer fiber preparation stations may be incorporated into the various exemplary embodiments. Furthermore, the stations employed may perform different fiber preparation functions than those described. Such variations are not regarded as a departure from the spirit and scope of the invention, and such modifications as would be obvious to one skilled in the art are intended to be included within the scope of the following claims and their legal equivalents.

We claim:

1. A method of preparing an optical fiber, the method comprising:
(a) moving the optical fiber to a fiber straightening station which straightens the fiber;
(b) moving the optical fiber to a fiber stripping station which substantially removes at least a portion of a buffer layer;
(c) moving the optical fiber to a fiber cleaning station which substantially removes debris and contaminants from the portion of the fiber exposed in b); and
(d) moving the optical fiber to a fiber cleaving station, which cleaves the fiber.

2. A method as recited in claim 1, wherein the optical fiber is oriented substantially vertically in (a) through (d).

3. A method as recited in claim 1, wherein said fiber straightening station applies heat to the fiber to substantially remove curl from the fiber.

4. A method as recited in claim 1, wherein said fiber stripping station moves to remove said portion of said buffer layer.

5. A method as recited in claim 4, wherein a vacuum take-away substantially removes said removed portion of said buffer layer.

6. A method as recited in claim 1, wherein said fiber cleaning station further comprises a bath.

7. A method as recited in claim 6, wherein bath vibrates.

8. A method as recited in claim 1, further comprising:
applying a substantially constant tension to the optical fiber prior to (d).

9. A method as recited in claim 8, wherein said removing of said cleaved portion is via a vacuum take-away.

10. A method as recited in claim 1, wherein the fiber stripping station cuts the fiber to a prescribed length.

11. A method as recited in claim 1, wherein the fiber straightening station cuts the fiber to a prescribed length.

12. A method as recited in claim 10, wherein excess fiber is removed by a vacuum take-away.

13. A method as recited in claim 11, wherein excess fiber is removed by a vacuum take-away. away.

14. A fiber preparation apparatus, comprising:
A fiber holder transport;
a fiber straightening station;
a fiber stripping station;
a fiber cleaning station; and
a fiber cleaving station.

15. An apparatus as recited in claim 14, wherein said fiber holder transport holds a plurality of optical fibers in a substantially vertical orientation.

16. An apparatus as recited in claim 14, wherein said fiber holder transport further comprises a magazine, and said magazine includes a plurality of positions each of which receives a fiber holder.

17. An apparatus as recited in claim 14, wherein said magazine is substantially cylindrical and rotates about a shaft.

18. An apparatus as recited in claim 17, wherein said shaft is connected to a servo motor.

19. An apparatus as recited in claim 14, wherein said fiber straightening station further includes a heating mechanism.

20. An apparatus as recited in claim 17, wherein said heating mechanism is chosen from the group consisting essentially of convective heating, radiative heating and conductive heating.

21. An apparatus as recited in claim 19, wherein said heating mechanism includes hot gas projected over a buffer layer of an optical fiber.

22. An apparatus as recited in claim 14, wherein said stripping station further includes stripping blades.

23. An apparatus as recited in claim 21, wherein hot gas is blown through channels in a heated block and onto said fiber.

24. An apparatus as recite din claim 14, wherein said fiber stripping station further includes a heated tube and stripper blades.

25. An apparatus as recited in claim 24, wherein said fiber stripping station further includes a vacuum take-away.

26. An apparatus as recited in claim 19, wherein hot gases are projected over said buffer layer.

27. An apparatus as recited in claim 14, wherein said fiber cleaning station further comprises a bath.

28. An apparatus as recited in claim 27, wherein said bath vibrates at ultrasonic frequencies.

29. An apparatus as recited in claim 14, wherein said cleaving station further comprises fiber grippers and a tensioning slide.

30. An apparatus as recited in claim 29, wherein said tensioning slide applies a dead-weight to said fiber.

31. An apparatus as recited in claim 14, wherein said cleaving station further comprises a vacuum take-away.

32. An apparatus as recited in claim 14, wherein said cleaving station further comprises a flaw inducer which is moved at a controlled speed and position.

33. An apparatus as recited in claim 14, wherein said cleaving station further comprises a flaw inducer that includes an ultrasonically agitated sharp edge.

34. An apparatus as recited in claim 14, wherein said cleaving station further comprises a flaw inducer motion mechanism which includes a servo motor and a warm gear.

35. An apparatus as recited in claim 14, wherein said cleaving station further comprises a flaw inducer motion mechanism which includes a rotational piezoelectric motor.

36. An apparatus as recited in claim 14, wherein said fiber straightening station, said fiber stripping station, said fiber cleaning station and said fiber cleaving station each include at least one fiber lead-in.

37. An apparatus as recited in claim 36, wherein each of said fiber lead-ins includes a substantially conical opening.

38. A method of optical fiber preparation, the method comprising:
concurrently processing a plurality of optical fibers which have a substantially vertical orientation, and said concurrent processing is substantially automated.

39. A method as recited in claim 38, wherein said processing further comprises performing operations chosen from the group consisting essentially of straightening said: optical fibers, cutting said optical fibers to a predetermined length, stripping at least one buffer layer from said optical fibers, cleaning said optical fibers, and cleaving said optical fibers.

40. A method as recited in claim 38, wherein the method further comprises moving a flaw inducer at a controlled speed and position.

41. A method as recited in claim 39, wherein said straightening includes applying heat.

42. A method as recited in claim 40, wherein the flaw inducer is an ultrasonically agitated sharp edge.

43. A fiber preparation apparatus, comprising:
An optical fiber holder transport which holds at least one vertically oriented optical fiber; and
at least one fiber processing station.

44. A fiber preparation apparatus as recited in claim 43, wherein said fiber holder transport moves said at least one vertically oriented optical fiber to said at least one fiber processing station.

45. A fiber preparation apparatus as recited in claim 44, wherein said fiber holder transport moves.

46. A fiber preparation apparatus as recited in claim 45, wherein said fiber holder transport rotates.

47. A fiber preparation apparatus as recited in claim 44, wherein said fiber holder transport is substantially stationary, and includes at least one track through which said at least one vertically oriented optical fiber moves.

48. A fiber preparation apparatus as recited in claim 43, wherein the apparatus further comprises a plurality of fiber processing stations.

49. A fiber preparation apparatus as recited in claim 43, wherein said plurality of fiber processing stations are chosen from the group consisting essentially of a fiber straightening station, a fiber stripping station, a fiber cleaning station and a fiber cleaving station.

50. A fiber preparation apparatus as recited in claim 43, wherein said fiber holder transport is substantially stationary and said at least one vertically oriented optical fiber moves relative to said fiber holder transport
